(19) United States
(12) Patent Application Publication
(10) Pub. No.: US 2009/0202051 A1
(43) Pub. Date: Aug. 13, 2009

(54) Custom voicemail greeting message based on caller

(76) Inventors: Satpreet Singh, Plano, TX (US); Sundara Senthil, Garland, TX (US)

Correspondence Address: ROBERT E. BUSHNELL & LAW FIRM, 2029 K STREET NW, SUITE 600, WASHINGTON, DC, 20006-1004, US

(21) Appl. No.: 12/068,738

(22) Filed: Feb. 11, 2008

(51) Int. Cl. H04M 1/64

(52) U.S. Cl. 379/88.19

(57) ABSTRACT

A method and apparatus for providing customized voicemail greeting messages. A user device is constructed with a memory unit storing a plurality of customized voicemail greeting messages in association with respective contact information. When the user device receives an incoming call from a caller and the call has not been answered after a certain time, the user device may play the customized voicemail greeting message to the caller.

### BACKGROUND OF THE INVENTION

1. Field of the Invention

The present invention relates to a method and apparatus for providing customized voicemail greeting messages.

2. Description of the Related Art

Telephone systems have become increasingly sophisticated and are designed to provide many services to companies, cellular and residential subscribers. Among the many services, voicemail service had become a ubiquitous feature on telephone systems serving the subscriber.

The voicemail service employs a centralized, computerized system to manage telephone messages for a large group of people. In a the voicemail service system, when a user receives an incoming phone call from a caller and the user does not answer the phone after a certain time, a voicemail greeting message will be transmitted to the caller. After hearing the voicemail greeting message, the caller may record a voicemail message in a voicemail system.

Unfortunately, with the increasing sophistication of telephone systems, current voicemail greeting message is common to all callers, which is stored in one place like a service provider (network) place and played to all callers. Therefore, current voicemail greeting message lacks a feature of customizing greeting messages to the callers.

### SUMMARY OF THE INVENTION

It is therefore an object of the present invention to provide an improved method and an improved apparatus for communication.

It is another object of the present invention to provide an improved method and apparatus to enable generation of customized voice mail greeting messages.

According to one aspect of the present invention, an apparatus for communication is provided with a recording unit for recording at least one customized voicemail greeting message; and a memory unit for storing at least one entry of contact information and the at least one customized voicemail greeting message in association with the entry of contact information.

The apparatus may further provided with a call processing unit for processing incoming calls and outgoing calls. When an incoming call received from a caller has not been answered after a certain time, the call processing unit retrieves the contact information of the caller, and determines whether the memory unit stores a customized voicemail greeting message associated with the retrieved contact information of the caller. When the memory unit stores a customized voicemail greeting message associated with the retrieved contact information of the caller, the calling processing unit transmits the customized voicemail greeting message to the caller.

According to another aspect of the present invention, a method for communication is provided. At least one customized voicemail greeting message for at least one contact among a plurality of contacts listed in a phone book is recorded in a memory unit disposed within a user device communicating with a communication network. The customized voicemail greeting message is recorded in association with the contact information of the corresponding contact. When an incoming call received by the user device through the communication network from a caller has not been answered after a certain time, the contact information of the caller is received, and the user device determines whether the memory unit stores a customized voicemail greeting message associated with the retrieved contact information of the caller. When the memory unit stores a customized voicemail greeting message associated with the retrieved contact information of the caller, the user device transmits the customized voicemail greeting message to the caller.

When the memory unit does not store a customized voicemail greeting message associated with the contact information of the caller, a network controlling unit in the communication network may transmit a default voicemail greeting message to the caller after another certain time.

According to still another aspect of the present invention, a communication system is provided with a network controlling unit transmitting an incoming call received from a caller to a user device. When the incoming call has not been answered after a certain time, the user device determines whether a memory unit disposed within the user device stores a customized voicemail greeting message corresponding to the caller. When the memory unit stores a customized voicemail greeting message corresponding to the caller, the user device transmits the customized voicemail greeting message to the caller.

When the memory unit within the user device does not store a customized voicemail greeting message corresponding to the caller, the network controlling unit may transmit a default voicemail greeting message to the caller.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 schematically illustrates a block diagram of a communication network system according to one embodiment of the principles of the present invention; and

FIG. 2 is a flow chart illustrating a process for a user device to answer an incoming phone call according to the embodiment of the principles of the present invention.

### DETAILED DESCRIPTION OF THE INVENTION

The present invention will now be described more fully hereinafter with reference to the accompanying drawings.

The present invention provides a custom voicemail greeting message for a contact in a mobile phone book. The voicemail greeting message is recorded and stored as a part of the phone book entry. When a person calls and if the phone book contains a voicemail greeting message corresponding to that person, the call will be answered by playing the voicemail greeting message. With this, the information need to be passed to that particular person is conveyed with unique voicemail instead of traditional way. If there is no voicemail greeting for that person, then the call won't be answered and after a certain time, a default voicemail greeting message stored in networked will be played.

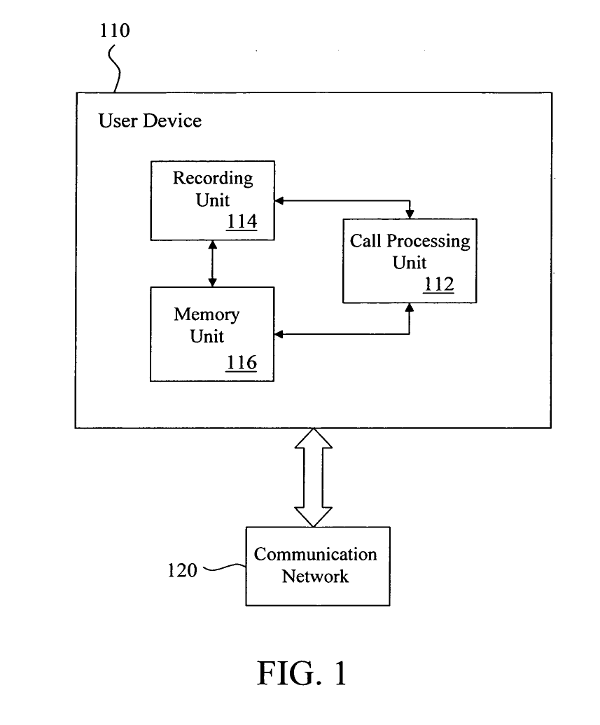

FIG. 1 schematically illustrates a block diagram of a communication network system including a user device according to one embodiment of the principles of the present invention. The communication network system may be any network such as a Global System for Mobile communications (GSM) network, a Code division multiple access (CDMA) network, or a the Worldwide Interoperability for Microwave Access (WiMAX) network. The user device may be any phone such as a landline phone, a mobile device, a Personal digital assistant (PDA), or a Smart phone.

As illustrated in FIG. 1, user device 110 is constructed with a call processing unit 112 for processing incoming and outgoing phone calls, a recording unit 114 for recording voicemail greeting messages, and a memory unit 116 for storing a phone book including a plurality of entries of contact information. The contact information could be at least one of a telephone number, and the identity of the contact. A user of user device 110 may use recording unit 114 to record a customized voicemail greeting message for a specific contact in the phone book. The voicemail greeting message is then stored in memory unit in association with the corresponding entry of the contact information.

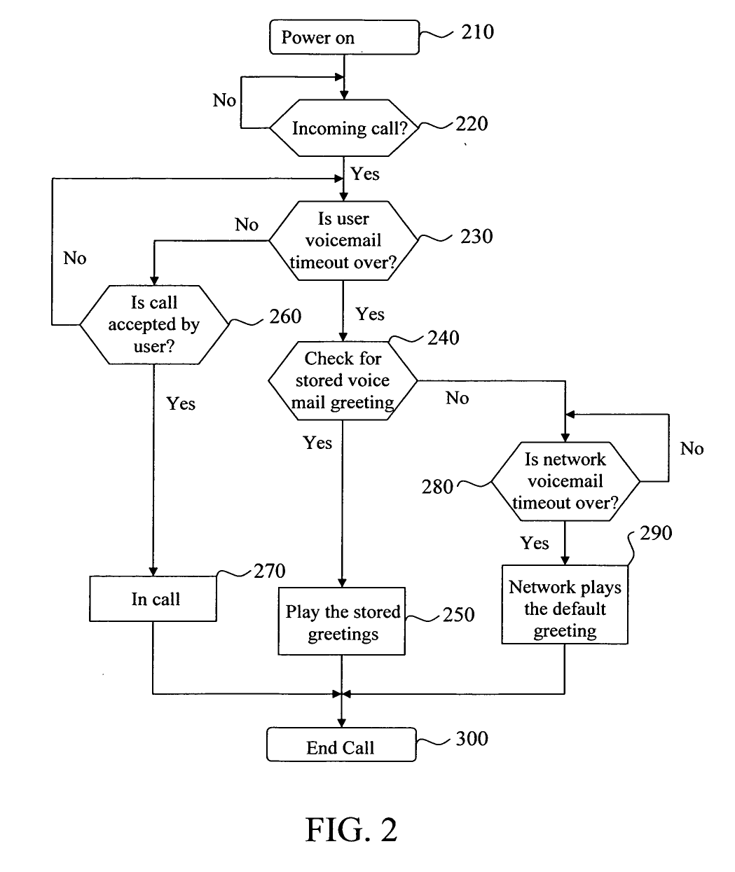

FIG. 2 is a flow chart illustrating a process for a user device to answer an incoming phone call according to one embodiment of the principles of the present invention. After the power of user device 110 is turned on (step 210), call processing unit 112 in user device 110 constantly checks whether there is an incoming call (step 220). When user device 110 receives an incoming call from a caller, call processing unit 112 in user device 110 determines whether a user voicemail timeout time tᵤₛₑᵣ is over (step 230). The user voicemail timeout time tᵤₛₑᵣ may be configured to be constant for all user devices within the communication network. Alternatively, the user voicemail timeout time tᵤₛₑᵣ may be configured to be different for different user device. When the user voicemail timeout time tᵤₛₑᵣ is not over, call processing unit 112 determines whether the incoming call is accepted by the user of user device 110 (step 260). When the incoming call is accepted, call processing unit 112 processes the incoming call (step 270), until the user ends the incoming call (step 300). When the incoming call is not accepted and the user voicemail timeout time tᵤₛₑᵣ is over, call processing unit 112 determines whether memory unit 116 stores a customized voicemail greeting message for the caller (step 240). When there is a customized voicemail greeting message, call processing unit 112 plays the voicemail greeting message (step 250). When there is no customized voicemail greeting message for that caller, a controller (not shown) in communication network 120 determines whether a network voicemail timeout time t_{network} is over (step 280). When the network voicemail timeout time t_{network} is over, the controller in communication network 120 plays a default greeting message (step 290). Note that tᵤₛₑᵣ is less than t_{network} (tᵤₛₑᵣ<t_{network}). Then, after hearing the greeting message, the caller may record a voicemail message either in user device 110 or in a memory unit (not shown) in communication network 120.

By implementing the custom voicemail greetings according to the principles of the present invention, we are not restricted to a single voicemail greeting played by network. This feature enables to have custom voicemail greeting for each contact, so the restriction of single voicemail greetings is avoided.

While the present invention has been shown and described in connection with the preferred embodiments, it will be apparent to those skilled in the art that modifications and variations can be made without departing from the spirit and scope of the invention as defined by the appended claims.

What is claimed is:

1. An apparatus for communication, comprising:
a recording unit recording at least one customized voicemail greeting message; and
a memory unit storing at least one entry of contact information and the at least one customized voicemail greeting message in association with the entry of contact information.

2. The apparatus of claim 1, further comprising a call processing unit processing incoming calls and outgoing calls, with:
when an incoming call received from a caller has not been answered after a certain time, the call processing unit retrieving the contact information of the caller, and making a determination regarding whether the memory unit stores a customized voicemail greeting message associated with the retrieved contact information of the caller; and
when the memory unit stores a customized voicemail greeting message associated with the retrieved contact information of the caller, the calling processing unit transmitting the customized voicemail greeting message to the caller.

3. A method for communication, the method comprising the steps of:
recording, in a memory unit disposed within a user device communicating with a communication network, at least one customized voicemail greeting message for at least one contact among a plurality of contacts listed in a phone book, with the customized voicemail greeting message being recorded in association with the contact information of the corresponding contact;
when an incoming call received by the user device through the communication network from a caller has not been answered after a certain time, retrieving the contact information of the caller, and making a determination regarding whether the memory unit stores a customized voicemail greeting message associated with the retrieved contact information of the caller; and
when the memory unit stores a customized voicemail greeting message associated with the retrieved contact information of the caller, transmitting, by the user device, the customized voicemail greeting message to the caller.

4. The method of claim 3, further comprising the step of, when the memory unit does not store a customized voicemail greeting message associated with the contact information of the caller, transmitting, by a network controlling unit in the communication network, a default voicemail greeting message to the caller after another certain time.

5. A communication system, comprising:
a network controlling unit transmitting an incoming call received from a caller;
a user device receiving the incoming call from the network controlling unit, with, when the incoming call has not been answered after a certain time, the user device:
determining whether a memory unit disposed within the user device stores a customized voicemail greeting message corresponding to the caller;
when the memory unit stores a customized voicemail greeting message corresponding to the caller, transmitting the customized voicemail greeting message to the caller.

6. The communication system of claim 5, comprised of, when the memory unit within the user device does not store a customized voicemail greeting message corresponding to the caller, the network controlling unit transmitting a default voicemail greeting message to the caller.
